(19) United States
(12) Patent Application Publication
(10) Pub. No.: US 2025/0304264 A1
(43) Pub. Date: Oct. 2, 2025

(54) ENVIRONMENTAL CONTROL SYSTEM USING ARCHITECTURE WITH TURBINES IN SERIES

(71) Applicant: Hamilton Sundstrand Corporation, Charlotte, NC (US)

(72) Inventors: Louis J. Bruno, Ellington, CT (US); Aiden Coutin, Ogden, UT (US); Kayla Gosse, Ellington, CT (US)

(21) Appl. No.: 19/018,457

(22) Filed: Jan. 13, 2025

Related U.S. Application Data
(60) Provisional application No. 63/573,056, filed on Apr. 2, 2024.

(51) Int. Cl. B64D 13/08; B64D 13/06

(52) U.S. Cl. CPC B64D 13/08; B64D 2013/0618; B64D 2013/0648

(57) ABSTRACT

An environmental control system of a vehicle includes a first inlet for receiving a first medium, a second inlet for receiving a second medium, an outlet. The outlet is only fluidly connected to the second inlet. A ram air circuit including at least one ram heat exchanger is fluidly connected to at least one of the first inlet and the second inlet. A thermodynamic device includes a compressor and a plurality of turbines operably coupled by a shaft. The thermodynamic device is fluidly coupled to both the first inlet and the second inlet. A first cooling medium is provided to the ram air circuit during a first mode of operation, and a second cooling medium is provided to the ram air circuit during a second mode of operation.

### CROSS-REFERENCE TO RELATED APPLICATIONS

This application claims the benefit of U.S. Application No. 63/573,056 filed Apr. 2, 2024, the contents of which are incorporated by reference herein in its entirety.

### BACKGROUND

Embodiments of the disclosure relate to environmental control systems, and more specifically to an environmental control system of an aircraft.

In general, contemporary air condition systems are supplied a pressure at cruise that is approximately 30 psig to 35 psig. The trend in the aerospace industry today is towards systems with higher efficiency. One approach to improve airplane efficiency is to eliminate the bleed air entirely and use electrical power to compress outside air. A second approach is to use lower engine pressure. The third approach is to use the energy in the bleed air to compress outside air and bring it into the cabin. Unfortunately, each of these approaches provides limited efficiency with respect to engine fuel burn.

### SUMMARY

According to an embodiment, an environmental control system of a vehicle includes a first inlet for receiving a first medium, a second inlet for receiving a second medium, an outlet. The outlet is only fluidly connected to the second inlet. A ram air circuit including at least one ram heat exchanger is fluidly connected to at least one of the first inlet and the second inlet. A thermodynamic device includes a compressor and a plurality of turbines operably coupled by a shaft. The thermodynamic device is fluidly coupled to both the first inlet and the second inlet. A first cooling medium is provided to the ram air circuit during a first mode of operation, and a second cooling medium is provided to the ram air circuit during a second mode of operation.

In addition to one or more of the features described above, or as an alternative to any of the foregoing embodiments, the first cooling medium is ram air.

In addition to one or more of the features described above, or as an alternative to any of the foregoing embodiments during the first mode of operation, both the first cooling medium and the second cooling medium is provided to the ram air circuit.

In addition to one or more of the features described above, or as an alternative to any of the foregoing embodiments during the second mode of operation, both the first cooling medium and the second cooling medium are provided to the ram air circuit. A flow of the first cooling medium to the ram air circuit in the second mode of operation is less than the flow of the first cooling medium in the first mode of operation.

In addition to one or more of the features described above, or as an alternative to any of the foregoing embodiments during the second mode of operation, only the second cooling medium is provided to the ram air circuit.

In addition to one or more of the features described above, or as an alternative to any of the foregoing embodiments, an expansion device separate from the thermodynamic device is operably coupled to the thermodynamic device and to the outlet.

In addition to one or more of the features described above, or as an alternative to any of the foregoing embodiments, the expansion device is fluidly coupled to the compressor.

In addition to one or more of the features described above, or as an alternative to any of the foregoing embodiments a first flow path extends between the first inlet and the at least one ram heat exchanger and a second flow path extends between the first inlet and a turbine of the plurality of turbines of the thermodynamic device. The first flow path and the second flow path are arranged in parallel.

In addition to one or more of the features described above, or as an alternative to any of the foregoing embodiments, a valve is disposed along the second flow path, the valve being operable to control a flow to the turbine.

In addition to one or more of the features described above, or as an alternative to any of the foregoing embodiments, the second medium is fresh air.

In addition to one or more of the features described above, or as an alternative to any of the foregoing embodiments, the compressor is driven only by energy extracted from the first medium.

In addition to one or more of the features described above, or as an alternative to any of the foregoing embodiments, the first medium is bleed air.

According to an embodiment, a method of operating an environmental control system includes providing a first inlet for receiving a first medium, a second inlet for receiving a second medium, and an outlet. The outlet is only fluidly connected to the second inlet. The method further includes providing a ram air circuit including at least one ram heat exchanger fluidly connected to at least one of the first inlet and the second inlet. During a first mode of operation, cooling at least one of the first medium and the second medium within the at least one ram heat exchanger via a first cooling medium and during a second mode of operation, cooling at least one of the first medium and the second medium within the at least one ram heat exchanger via a second cooling medium.

In addition to one or more of the features described above, or as an alternative to any of the foregoing embodiments during the first mode of operation, cooling at least one of the first medium and the second medium within the at least one ram heat exchanger via the second cooling medium.

In addition to one or more of the features described above, or as an alternative to any of the foregoing embodiments during the second mode of operation, cooling at least one of the first medium and the second medium within the at least one ram heat exchanger via the first cooling medium. A flow of the first cooling medium in the second mode of operation is less than the flow of the first cooling medium in the first mode of operation.

In addition to one or more of the features described above, or as an alternative to any of the foregoing embodiments during the second mode of operation, cooling at least one of the first medium and the second medium within the at least one ram heat exchanger via only the second cooling medium.

In addition to one or more of the features described above, or as an alternative to any of the foregoing embodiments driving a compressor via energy extracted from the first medium at one or more of a plurality of turbines.

In addition to one or more of the features described above, or as an alternative to any of the foregoing embodiments dividing a flow of the first medium into a first portion and a second portion and extracting energy from the first portion at a turbine of the plurality of turbines and extracting energy from the second portion at another turbine of the plurality of turbines.

In addition to one or more of the features described above, or as an alternative to any of the foregoing embodiments, the first medium is bleed air and the second medium is fresh air.

### BRIEF DESCRIPTION OF THE DRAWINGS

The subject matter is particularly pointed out and distinctly claimed in the claims at the conclusion of the specification. The forgoing and other features, and advantages thereof are apparent from the following detailed description taken in conjunction with the accompanying drawings in which:

The FIGURE is a schematic diagram of an environmental control system pack according to an embodiment.

### DETAILED DESCRIPTION

A detailed description of one or more embodiments of the disclosed apparatus and method are presented herein by way of exemplification and not limitation with reference to the FIGS.

Embodiments herein provide an environmental control system of an aircraft that receives multiple mediums from different sources and uses energy from one or more of the mediums to operate the environmental control system and to provide cabin pressurization and cooling at a high fuel burn efficiency. The mediums described herein are generally types of air; however, it should be understood that other mediums, such as gases, liquids, fluidized solids, or slurries are also contemplated herein.

With reference now to the FIGURE, an example of a schematic diagram of a portion of an environment control system (ECS) 20, such as an air conditioning unit or pack for example, is depicted according to a non-limiting embodiment. Although the environmental control system or ECS pack 20 is described with reference to an aircraft, alternative applications, such as another vehicle for example, are also within the scope of the disclosure. As shown, the ECS 20 may be configured to receive a first medium A1 at a first inlet 22. In embodiments where the ECS 20 is used in an aircraft application, the first medium A1 is bleed air, which is pressurized air originating from, i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

The ECS 20 may alternatively or additionally be configured to receive a second medium A2 at a second inlet 24. In an embodiment, the second medium A2 is fresh air, such as outside air for example. The outside air can be procured via one or more scooping mechanisms, such as an impact scoop or a flush scoop for example. Thus, the second inlet 24 can be considered a fresh or outside air inlet. In an embodiment, the second medium A2 is ram air drawn from a portion of a ram air circuit. Generally, the second medium A2 described herein is at an ambient pressure equal to an air pressure outside of the aircraft when the aircraft is on the ground and is between an ambient pressure and a cabin pressure when the aircraft is in flight. In an embodiment, a conditioned form of only the second medium A2 is provided to one or more loads via an outlet of the ECS 20 during normal operating conditions.

The ECS 20 may include a RAM air circuit 30 including a shell or duct, illustrated schematically at 32, within which one or more heat exchangers can be located. The shell 32 can receive and direct a medium, such as ram air RA for example, through a portion of the ECS 20. The one or more heat exchangers are devices built for efficient heat transfer from one medium to another. Examples of the type of heat exchangers that may be used, include, but are not limited to, double pipe, shell and tube, plate, plate and shell, adiabatic shell, plate fin, pillow plate, and fluid heat exchangers.

The one or more heat exchangers arranged within the shell 32 may be referred to as ram heat exchangers. In the illustrated, non-limiting embodiment, the at least one ram heat exchanger includes a first or primary heat exchanger 34 and a secondary or second heat exchanger 36. However, any suitable number of heat exchangers may be contemplated herein. Within the heat exchangers 34, 36, ram air, such as outside air for example, acts as a heat sink to cool a medium passing there through, for example the first medium A1 and/or the second medium A2. Although the plurality of ram air heat exchangers 34, 36 are illustrated as being arranged in series relative to a flow through the ram air circuit 30, it should be understood that in other embodiments, the plurality of heat exchangers 34, 36 may be arranged in parallel or some combination of series and parallel.

As shown. the ECS 20 may additionally include at least one thermodynamic device 40, and in some embodiments includes a plurality of thermodynamic devices. Each thermodynamic device 40 is a mechanical device that includes components for performing thermodynamic work on a medium (e.g., extracts work from or applies work to the first medium A1, the second medium A2 by raising and/or lowering pressure and by raising and/or lowering temperature). Examples of a thermodynamic device include an air cycle machine, a two-wheel air cycle machine, a three-wheel air cycle machine, a four-wheel air cycle machine, etc.

In the illustrated, non-limiting embodiments, the ECS 20 includes a single thermodynamic device 40. However, embodiments including more than one thermodynamic device are also contemplated herein. The thermodynamic device 40 may include a compressor 42 and at least one turbine operably coupled by a shaft 44. In an embodiment, the thermodynamic device 40 includes three turbines 46, 48, and 50. In such embodiments, a medium, such as the first medium A1 for example, may be configured to flow through one or more the plurality of turbines 46, 48, 50 based on a mode of operation.

A compressor 42 is a mechanical device configured to raise a pressure of a medium and can be driven by another mechanical device (e.g., a motor or a medium via a turbine). Examples of compressor types include centrifugal, diagonal or mixed-flow, axial-flow, reciprocating, ionic liquid piston, rotary screw, rotary vane, scroll, diaphragm, air bubble, etc. A turbine, such as any of turbines 46, 48, and 50 for example, is a mechanical device that expands a medium and extracts work therefrom (also referred to as extracting energy) to drive the compressor 42 via the shaft 44.

In the illustrated, non-limiting embodiment, the ECS 20 additionally includes an expansion device 52. The expansion device 52 is a mechanical device, similar to the thermodynamic device 40, and includes components for performing thermodynamic work on a medium (e.g., extracts work from or applies work to the first medium A1 by raising and/or lowering pressure and by raising and/or lowering temperature). Examples of the expansion device 52 include, but are not limited to, a simple air cycle machine or a tip turbine fan etc. Although the expansion device 52 is not described herein as a thermodynamic device, it should be understood that in some embodiments, the expansion device 52 may be considered a thermodynamic device.

In the illustrated, non-limiting embodiment, the expansion device 52 is a two-wheel air cycle machine including a turbine 54 and a fan 56 operably coupled via a shaft 58. However, it should be understood that any suitable expansion device, including an air cycle machine having any number of wheels (i.e., three-wheel or four-wheel) are also within the scope of the disclosure. The turbine 54 is a mechanical device that expands a medium and extracts work therefrom. In the expansion device 52, the turbine 54 drives rotation of the fan 56 via the shaft 58. In a non-limiting embodiment, the turbine 54 comprises a nozzle configured to accelerate a medium supplied thereto for entry into a turbine impeller (not shown). The fan 56 is a mechanical device that can force via push or pull methods a medium. For example, the fan 56 may be operable to move ram air through the shell 32 across the one or more ram heat exchangers 34, 36.

The elements of the ECS 20 are connected via valves, tubes, pipes, and the like. Valves (e.g., flow regulation device or mass flow valve) are devices that regulate, direct, and/or control a flow of a medium by opening, closing, or partially obstructing various passageways within the tubes, pipes, etc. of the system. Valves can be operated by actuators, such that flow rates of the medium in any portion of the system can be regulated to a desired value. For instance, a first valve V1 is configured to control a supply of the first medium A1 provided to the ECS 20. A second valve V2 may be operable to control a flow of one medium, such as the first medium A1 at a location upstream from the ram air circuit 30, to one of the turbines, such as the third turbine 50 for example. Valve V2 may be operated in flight to provide additional power to the compressor 42. A third valve V3 may be operable to allow a flow of the first medium to bypass one of the turbines, such as the first turbine 46. Valve V3 is also operable to maintain the temperature at the outlet of the first turbine 46 above freezing. A fourth valve V4 may be operable to allow a flow of the second medium to bypass one of the turbines, such as turbine 54 of the expansion device 52 for example. The fourth valve V4 is also operable to maintaining a temperature of the conditioned medium at the pack outlet to a desired level based on cabin and flight deck demands. A fifth valve V5 may be operable to provide surge control of the compressor 42.

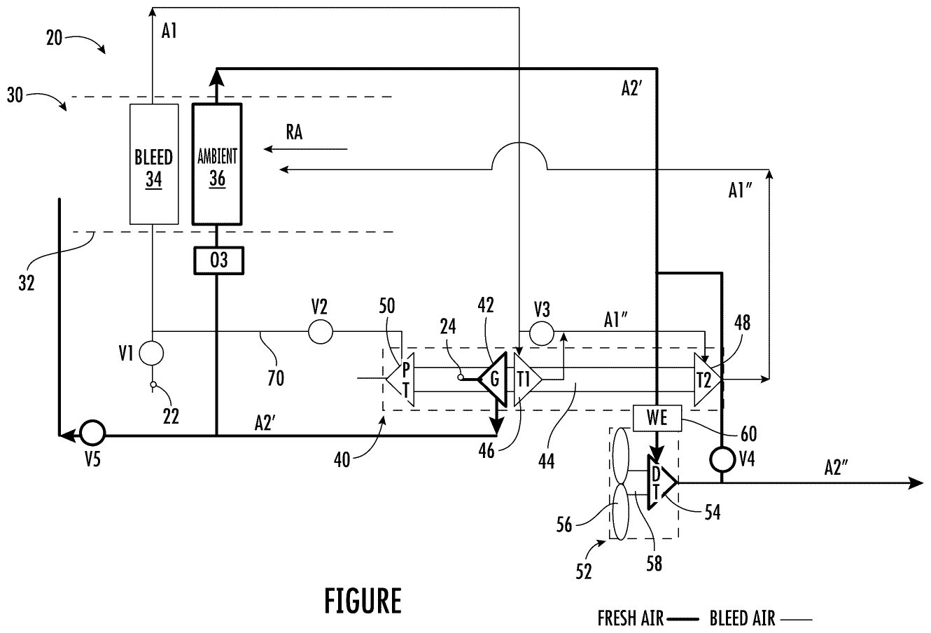

The environmental control system of FIG. 1 may be operable in a plurality of modes based on a flight condition of the aircraft. For example, the ECS 20 may be operable in a first or “ground mode” for ground and low altitude flight conditions such as ground idle, taxi, take-off, and hold conditions. During operation in the first mode, a flow of high-pressure, high-temperature first medium A1 is provided from the first inlet 22 to the primary heat exchanger 34 of the ram air circuit 30. Ram air RA provided to the primary heat exchanger 34 cools the first medium A1. From the outlet of the heat exchanger 34, the high pressure first medium A1 enters the turbine 46 through a nozzle. Within the turbine 46, the first medium A1 is expanded and work is extracted. The work from the first turbine 46 is used to drive the compressor 42 which is used to compress the second medium A2. The warm, dry first expanded medium A1″ output from the first turbine 46 may then be provided to a second turbine 48 where it is expanded and work is extracted therefrom. Accordingly, the first medium A1 may be provided to the first turbine 46 and the second turbine 48 in series. From the second turbine 48, the further expanded first medium A1″ may be exhausted into the ram air circuit 30. In an embodiment, the expanded first medium A1″ is mixed with the ram air within the ram air circuit 30 and the mixture is used to cool the second medium A2 within the second heat exchanger 36 and/or the first medium A1 within the primary heat exchanger 34.

The work extracted from the first and second turbine 46, 48 drives the compressor 42 which is used to compress the second medium A2 provided to the compressor 42 from the second inlet 24. The act of compressing the second medium A2 heats it. From the compressor 42, the hot, compressed second medium A2′ may be delivered to an inlet of the second heat exchanger 36. Within the second heat exchanger 36, the compressed second medium A2′ is cooled, such as by ram air RA and/or the flow of the expanded first medium A1″ output from the second turbine 48. In an embodiment, the compressed second medium A2′ is cooled within the second heat exchanger 36 to a nearly ambient temperature such that moisture within the compressed second medium A2′ is condensed. From an outlet of the second heat exchanger 36, the compressed second medium A2″ may be provided to a water extractor 60 where any free moisture therein is removed. This cool dry compressed second medium A2′ may then enters the turbine 54 of the expansion device 52. Within the turbine 54, the compressed second medium A2′ is expanded and work is extracted to form an expanded second medium A2″. The act of extracting work from the second medium A2′ within the turbine 54 cools the second medium A2′ and drives the fan 56 about its axis. The flow of the expanded second medium A2″ output from the turbine 54 may then be delivered to one or more loads, such as the cabin for example.

A second mode of operation of the ECS 20 is a “high-altitude” operation. The high-altitude mode would be used for flight conditions such as at high altitude cruise, climb, and descent flight conditions. Operation of the ECS 20 in the high-altitude mode may be similar to operation on the ground. Accordingly, high pressure, high temperature first medium A1 is first cooled within the ram air circuit 30, such as at the primary heat exchanger 34, and is then provided to at least one of the first turbine 46 and second turbine 48. Similarly, the second medium A2 is compressed, cooled within the ram air circuit 30 and work is then extracted therefrom in the turbine 54 of the expansion device 52.

However, in the high-altitude mode, the expanded first medium A1″ output from the turbine 48 is the primary medium used to cool the first medium A1 and the second medium A2 within the heat exchanger 34, 36. In some embodiments, ram air RA may also be used in combination with the expanded first medium A1″; however, in such embodiments, the flow of ram air is less in the high-altitude mode than in the ground mode. In some embodiments, only the expanded first medium A1″ and not ram air RA may be used to cool the first medium A1 and the second medium A2 within the heat exchangers 34, 36, respectively. Accordingly, at least a first cooling medium, such as ram air RA may be used to cool the first and second mediums A1, A2 within the ram air circuit 30 during a first mode of operation and at least a second cooling medium, such as expanded first medium A1″ may be used to cool the first and second mediums A1, A2 within the ram air circuit 30 during a second mode of operation.

Further, in the high-altitude mode the second valve V2 is open. Accordingly, a flow of high pressure, high temperature first medium A1 is directed to the third turbine 50 of the thermodynamic device 40, via a conduit 70 fluidly coupling and defining a flow path extending between the first inlet 22 and the thermodynamic device 40. In such embodiments, the first inlet 22 fluidly connected to the primary heat exchanger 34, and therefore to the first and second turbines 46, 48 via a first flow path is arranged in parallel with a second flow path extending between the first inlet and the third turbine 50. Accordingly, a first portion of the first medium A1 at the first inlet 22 may be provided to the ram air circuit 30 and a second portion of the first medium A1 received at the first inlet 22 may simultaneously be provided to the thermodynamic device 40, such as to the third turbine 50. The second portion of the first medium A1 provided to the third turbine 50 is expanded and work is extracted therefrom. This work is used to drive the compressor 42 and may be supplemental to the work extracted from the first medium A1 in the first turbine 46 and the second turbine 48.

In the event of a failure of a pressurized air system and/or of an ECS pack 20 during flight, a remaining functional ECS pack may be configured to meet the demands of the aircraft. To maintain the pressure and/or flow rate requirements associated with operation in such a failure mode, the remaining operational ECS or ECS pack may be operated in a “single pack” mode of operation. Operation in the failure mode is similar to operation in the high-altitude mode.

In a failure mode, high pressure first medium A1 passes through the ram air circuit 30, such as through the primary heat exchanger 34 where the first medium A1 is cooled. From the ram air circuit 30, the first medium A1 is provided to and at least one of the first turbine 46 and second turbine 48. In an embodiment, valve V3 is open such that at least a portion of the flow of first medium A1 output from the ram air circuit 30, and in some embodiments substantially all of the first medium A1, bypasses the first turbine 46. The first medium A1 is provided to the second turbine 48 and the energy extracted from the first medium A1 at at least one of the first turbine 46 and second turbine 48 is used to drive the compressor 42. Additional energy is provided to the compressor 42 via a flow of medium, such as the first medium A1, supplied directly to the third turbine 50, such as by opening valve V2. By fully opening valve V3 additional first medium A1 is able to flow through the ECS 20 to meet cabin demands.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An environmental control system of a vehicle, the environmental control system comprising:
a first inlet for receiving a first medium and a second inlet for receiving a second medium;
an outlet, wherein the outlet is only fluidly connected to the second inlet;
a ram air circuit including at least one ram heat exchanger fluidly connected to at least one of the first inlet and the second inlet;
a thermodynamic device including a compressor and a plurality of turbines operably coupled by a shaft, the thermodynamic device being fluidly coupled to both the first inlet and the second inlet; and
wherein a first cooling medium is provided to the ram air circuit during a first mode of operation, and a second cooling medium is provided to the ram air circuit during a second mode of operation.

2. The environmental control system of claim 1, wherein the first cooling medium is ram air.

3. The environmental control system of claim 1, wherein during the first mode of operation both the first cooling medium and the second cooling medium is provided to the ram air circuit.

4. The environmental control system of claim 1, wherein during the second mode of operation both the first cooling medium and the second cooling medium are provided to the ram air circuit, wherein a flow of the first cooling medium to the ram air circuit in the second mode of operation is less than the flow of the first cooling medium in the first mode of operation.

5. The environmental control system of claim 1, wherein during the second mode of operation only the second cooling medium is provided to the ram air circuit.

6. The environmental control system of claim 1, further comprising an expansion device separate from the thermodynamic device, the expansion device being operably coupled to the thermodynamic device and to the outlet.

7. The environmental control system of claim 6, wherein the expansion device is fluidly coupled to the compressor.

8. The environmental control system of claim 1, wherein a first flow path extends between the first inlet and the at least one ram heat exchanger and a second flow path extends between the first inlet and a turbine of the plurality of turbines of the thermodynamic device, the first flow path and the second flow path being arranged in parallel.

9. The environmental control system of claim 8, further comprising a valve disposed along the second flow path, the valve being operable to control a flow to the turbine.

10. The environmental control system of claim 1, wherein the second medium is fresh air.

11. The environmental control system of claim 1, wherein the compressor is driven only by energy extracted from the first medium.

12. The environmental control system of claim 1, wherein the first medium is bleed air.

13. A method of operating an environmental control system, the method comprising:
providing first inlet for receiving a first medium, a second inlet for receiving a second medium, and an outlet, wherein the outlet is only fluidly connected to the second inlet;
providing a ram air circuit including at least one ram heat exchanger fluidly connected to at least one of the first inlet and the second inlet;
wherein during a first mode of operation, cooling at least one of the first medium and the second medium within the at least one ram heat exchanger via a first cooling medium; and
wherein during a second mode of operation, cooling at least one of the first medium and the second medium within the at least one ram heat exchanger via a second cooling medium.

14. The method of claim 13, further comprising wherein during the first mode of operation, cooling at least one of the first medium and the second medium within the at least one ram heat exchanger via the second cooling medium.

15. The method of claim 13, further comprising wherein during the second mode of operation, cooling at least one of the first medium and the second medium within the at least one ram heat exchanger via the first cooling medium, wherein a flow of the first cooling medium in the second mode of operation is less than the flow of the first cooling medium in the first mode of operation.

16. The method of claim 13, wherein during the second mode of operation, cooling at least one of the first medium and the second medium within the at least one ram heat exchanger via only the second cooling medium.

17. The method of claim 13, further comprising driving a compressor via energy extracted from the first medium at one or more of a plurality of turbines.

18. The method of claim 17, further comprising dividing a flow of the first medium into a first portion and a second portion and extracting energy from the first portion at a turbine of the plurality of turbines and extracting energy from the second portion at another turbine of the plurality of turbines.

19. The method of claim 13, wherein the first medium is bleed air and the second medium is fresh air.
